(19) United States
(12) Patent Application Publication
(10) Pub. No.: US 2025/0236993 A1
(43) Pub. Date: Jul. 24, 2025

(54) METHOD FOR REGENERATING CARBON FIBER BUNDLE AND APPARATUS FOR REGENERATING CARBON FIBER BUNDLE

(71) Applicant: HONDA MOTOR CO., LTD., Tokyo (JP)

(72) Inventor: Masato NOGUCHI, Saitama (JP)

(21) Appl. No.: 18/966,144

(22) Filed: Dec. 3, 2024

(30) Foreign Application Priority Data
Jan. 22, 2024 (JP) 2024-007591

(51) Int. Cl. D01F 13/04; C08J 11/04; D01F 9/12

(52) U.S. Cl. CPC D01F 13/04; C08J 11/04; D01F 9/12; D10B 2101/12

(57) ABSTRACT

Provided is a method for regenerating a carbon fiber bundle from a structure having a hollow substrate, and a carbon fiber reinforced resin layer including a carbon fiber bundle that is wound around the hollow substrate, and a matrix resin, the method including a first heating process of heating the structure to decompose a part of the matrix resin, an unwinding process of unwinding an intermediate carbon fiber bundle to which decomposition residue of the matrix resin is adhering from the carbon fiber reinforced resin layer in which a part of the matrix resin is decomposed, a second heating process of heating the unwound intermediate carbon fiber bundle to decompose the decomposition residue of the matrix resin by using a tube furnace, and thereby obtaining a regenerated carbon fiber bundle, and a winding process of winding the regenerated carbon fiber bundle.

This application is based on and claims the benefit of priority from Japanese Patent Application No. 2024-007591, filed on 22 Jan. 2024, the content of which is incorporated herein by reference.

### BACKGROUND OF THE INVENTION

### Field of the Invention

The present invention relates to a method for regenerating a carbon fiber bundle, and an apparatus that regenerates a carbon fiber bundle.

### Related Art

In recent years, by preventing generation of waste, and reducing, recycling and reusing waste, efforts to significantly reduce generation of waste have become more and more active. In order to realize this, research and development on methods for recovering carbon fibers from carbon fiber reinforced resin is being conducted.

Japanese Unexamined Patent Application, Publication No. 2022-15366 describes a method for recycling carbon fibers, including a process of thermally decomposing resin in a carbon fiber reinforced resin molded product by first heat treatment, and a process of drawing carbon fibers out of the carbon fiber reinforced resin molded product after the first heating treatment and winding the carbon fibers. At this time, the winding process includes a process that thermally decomposes residue of the resin adhering to the carbon fibers by second heat treatment, and a process of adding a sizing agent to the carbon fibers after the second heat treatment. Furthermore, the carbon fiber reinforced resin molded product is a tank including a liner, and a carbon fiber reinforced resin layer.

Patent Document 1: Japanese Unexamined Patent Application, Publication No. 2022-15366

### SUMMARY OF THE INVENTION

However, when the method for recycling carbon fibers of Japanese Unexamined Patent Application, Publication No. 2022-15366 is used, thermal energy is released, and outside air is mixed in, when the resin residue adhering to the carbon fibers is thermally decomposed by the second heat treatment. Therefore, it is difficult to thermally decompose the resin residue adhering to the carbon fibers stably and efficiently.

The present invention has an object to provide a method for regenerating a carbon fiber bundle and an apparatus for regenerating a carbon fiber bundle that can stably and efficiently decompose decomposition residue of a matrix resin by heating an intermediate carbon fiber bundle.

(1) A method for regenerating a carbon fiber bundle from a structure having a hollow substrate, and a carbon fiber reinforced resin layer including a carbon fiber bundle that is wound around the hollow substrate, and a matrix resin, the method including a first heating process of heating the structure to decompose a part of the matrix resin, an unwinding process of unwinding an intermediate carbon fiber bundle to which decomposition residue of the matrix resin is adhering from the carbon fiber reinforced resin layer in which a part of the matrix resin is decomposed, a second heating process of heating the unwound intermediate carbon fiber bundle to decompose the decomposition residue of the matrix resin by using a tube furnace, and thereby obtaining a regenerated carbon fiber bundle, and a winding process of winding the regenerated carbon fiber bundle, wherein the tube furnace has a heater that heats the intermediate carbon fiber bundle, and a lid that is installed at each of an inlet and an outlet, and has at least one through-hole through which the intermediate carbon fiber bundle can pass through formed in the lid.

(2) The method for regenerating a carbon fiber bundle according to (1), wherein in the tube furnace, a heating region where the intermediate carbon fiber bundle is heated, and a non-heating region where the intermediate carbon fiber bundles is not heated are present, and the non-heating region is present between the heating region and the inlet and/or between the heating region and the outlet.

(3) The method for regenerating a carbon fiber bundle according to (2), wherein the tube furnace further has an introduction tube that introduces oxidizing gas into the heating region.

(4) The method for regenerating a carbon fiber bundle according to (3), wherein the oxidizing gas is introduced along a surface of the intermediate carbon fiber bundle.

(5) The method for regenerating a carbon fiber bundle according to (3) or (4), wherein the oxidizing gas is introduced from a downstream side to an upstream side of the tube furnace.

(6) The method for regenerating a carbon fiber bundle according to any one of (3) to (5), wherein the introduction tube is disposed so that the oxidizing gas that is introduced into the heating region forms a turbulent flow.

(7) The method for regenerating a carbon fiber bundle according to any one of (1) to (6), wherein the at least one through-hole is slit-shaped, and is formed in a horizontal direction.

(8) The method for regenerating a carbon fiber bundle according to any one of (1) to (7), wherein in the lid, a plurality of the through-holes are formed.

(9) An apparatus that regenerates a carbon fiber bundle from a structure having a hollow substrate, and a carbon fiber reinforced resin layer including a carbon fiber bundle that is wound around the hollow substrate, and a matrix resin, the apparatus including a first heater that heats the structure to decompose a part of the matrix resin, an unwinder that unwinds an intermediate carbon fiber bundle to which decomposition residue of the matrix resin is adhering from the carbon fiber reinforced resin layer in which a part of the matrix resin is decomposed, a second heater that heats the unwound intermediate carbon fiber bundle to decompose the decomposition residue of the matrix resin, and thereby obtains a regenerated carbon fiber bundle, and a winder that winds the regenerated carbon fiber bundle, wherein the second heater is a tube furnace having a heater that heats the intermediate carbon fiber bundle, and a lid that is installed at each of an inlet and an outlet, and has at least one through-hole through which the intermediate carbon fiber bundle can pass through formed in the lid.

According to the present invention, it is possible to provide the method for regenerating a carbon fiber bundle and the device for regenerating a carbon fiber bundle that can stably and efficiently decompose the decomposition residue of a matrix resin by heating the intermediate carbon fiber bundle.

### BRIEF DESCRIPTION OF THE DRAWINGS

FIG. 1 is a sectional view showing an example of a high-pressure hydrogen tank;

FIG. 2 is a view showing an example of a first heater that is used in a first heating process;

FIG. 3A is a sectional view showing a rotator that rotates the high-pressure hydrogen tank in a heat treatment chamber in FIG. 2;

FIG. 3B is a side view showing a rotator that rotates the high-pressure hydrogen tank in the heat treatment chamber in FIG. 2;

FIG. 4A is a front view showing an example of an unwinder that is used in an unwinding process;

FIG. 4B is a side view showing an example of an unwinder that is used in an unwinding process;

FIG. 5 is a schematic view showing examples of a second heater, a sizing unit, and a winder that are used in a second heating process, a sizing process, and a winding process;

FIG. 6 is a front view showing a thermally insulated lid in FIG. 5;

FIG. 7 is a front view showing a modification of the thermally insulated lid in FIG. 6; and

FIG. 8 is a partially enlarged sectional view of a tube furnace in FIG. 5.

### DETAILED DESCRIPTION OF THE INVENTION

Hereinafter, an embodiment of the present invention will be described with reference to the drawings.

A method for regenerating a carbon fiber bundle according to one embodiment of the present invention is a method for regenerating a carbon fiber bundle from a structure having a hollow substrate, and a carbon fiber reinforced resin layer including a carbon fiber bundle wound around the hollow substrate and a matrix resin. Although the structure is not particularly limited, for example, known high-pressure hydrogen tanks (types 2 to 4) are cited.

Although the carbon fibers composing the carbon fiber bundles are not particularly limited, for example, polyacrylonitrile (PAN) carbon fibers, and pitch carbon fibers are cited. Here, the carbon fibers composing the carbon fiber bundles are long fibers. Fiber lengths of the carbon fibers are not particularly limited, but are 1 m or more, for example. Although the matrix resin is not particularly limited, for example, thermosetting resins such as epoxy resins, and thermoplastic resins are cited.

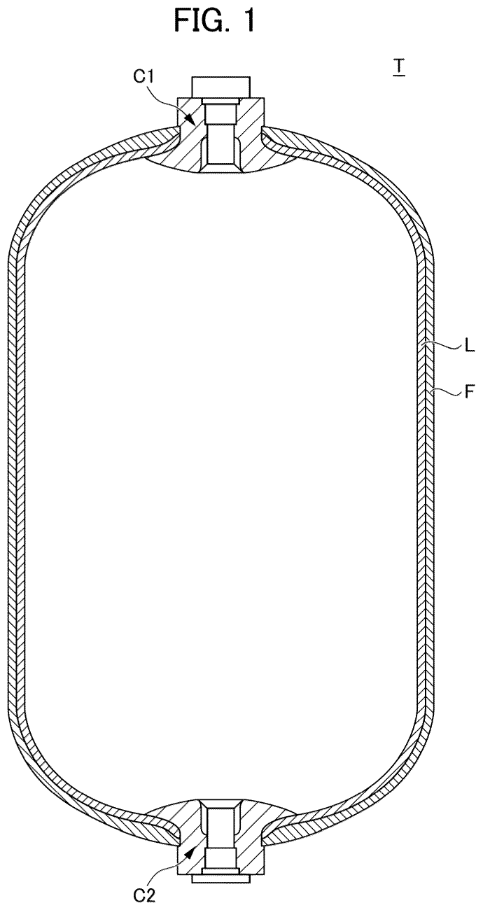

FIG. 1 shows an example of the high-pressure hydrogen tank.

A high-pressure hydrogen tank T has a liner L as a hollow substrate, a carbon fiber reinforced resin layer F including a carbon fiber bundle that is wound around the liner L and a matrix resin, and mouthpieces C1 and C2 that are installed in both end portions in a lengthwise direction. Although a material forming the liner L is not particularly limited, for example, metal such as aluminum, and chrome molybdenum steel, and resins such as polyamide and polyethylene are cited.

Although the method for manufacturing the high-pressure hydrogen tank T is not particularly limited, for example, a filament winding method is cited.

The method for regenerating a carbon fiber bundle according to one embodiment of the present invention includes a first heating process of heating the high-pressure hydrogen tank T to decompose a part of the matrix resin, and an unwinding process of unwinding an intermediate carbon fiber bundle I to which decomposition residue of the matrix resin is adhering from the carbon fiber reinforced resin layer in which a part of the matrix resin is decomposed. Furthermore, the method for regenerating a carbon fiber bundle according to one embodiment of the present invention further includes a second heating process of heating the unwound intermediate carbon fiber bundle I to decompose the decomposition residue of the matrix resin by using a tube furnace, and thereby obtaining a regenerated carbon fiber bundle R, and a winding process of winding the regenerated carbon fiber bundle R. Here, the tube furnace has a heater that heats the intermediate carbon fiber bundle I, and a lid that is installed at each of an inlet and an outlet, and has a through-hole through which the intermediate carbon fiber bundle I can pass formed in the lid. Accordingly, when the intermediate carbon fiber bundle I is heated to decompose the decomposition residue of the matrix resin by using the tube furnace, release of thermal energy and mixing of outside air are suppressed, as a result of which, the decomposition residue of the matrix resin is decomposed stably and efficiently.

The first heating process preferably includes a first step of decomposing the matrix resin at a temperature equal to or higher than a thermal decomposition start temperature of the matrix resin and equal to or lower than a flash point of thermal decomposition gas of the matrix resin, and a second step of decomposing the matrix resin that is decomposed in the first step, at a temperature equal to or higher than a thermo-oxidative decomposition start temperature of the decomposition residue of the matrix resin, and equal to or lower than a thermal decomposition start temperature of the carbon fibers. This suppresses overheating due to combustion of the thermal decomposition gas of the matrix resin, and deterioration of the carbon fibers.

When the matrix resin is an epoxy resin, for example, in the first step, the matrix resin is heated at a temperature of 330° C. or higher and 360° C. or lower, and in the second step, the matrix resin is heated at a temperature of 430° C. or higher ad 470° C. or lower. In this case, as the thermal decomposition gas, bisphenol A, phenol and the like are cited, for example.

Note that the heating temperature in the first heating step is not particularly limited as long as it is possible to unwind the carbon fiber bundles with the decomposition residue of the matrix resin adhering to the carbon fibers.

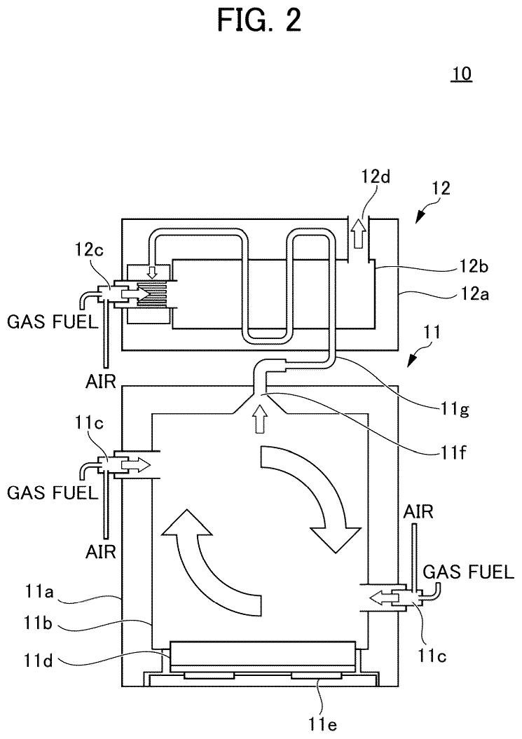

FIG. 2 shows a heat-treating furnace as an example of the first heater that is used in the first heating process.

A heat-treating furnace 10 has a heat treatment chamber 11 and a combustion chamber 12.

The heat treatment chamber 11 is an enclosed space surrounded by an outer wall 11a and an inner wall 11b. Furthermore, in the heat treatment chamber 11, a burner 11c is provided in each of an upper portion of the outer wall 11a on a left side and a lower portion of the outer wall 11a on a right side in the drawing so that combustion gas flows into the inner wall 11b. Accordingly, when gas fuel and air are mixed and combusted with the burners 11c, combustion gas circulates in the inner wall 11b by convection, and a temperature inside the inner wall 11b is stabled.

In the heat treatment chamber 11, a sealing door for containing the high-pressure hydrogen tank T is installed in part of the outer wall 11a and the inner wall 11b. Here, the high-pressure hydrogen tank T is placed on a thermal insulator 11d that is installed to penetrate a bottom surface of the inner wall 11b. Furthermore, a load cell 11e as a mass detector is installed between a bottom surface of the outer wall 11a and the thermal insulator 11d, and detects a mass of the high-pressure hydrogen tank T in real time, based on a distortion amount. Since heating conditions in the heat treatment chamber 11 is thereby optimized, variations in the decomposition amount of the matrix resin due to individual differences in the material forming the high-pressure hydrogen tank T, the shape and the like are suppressed, and management accuracy is improved. Furthermore, since the heating time in the heat treatment chamber 11 does not have to be longer than necessary, this contributes to shortening of the heating time and reduction of energy consumption.

Note that the mass detector may detect a decrease amount of the mass of the high-pressure hydrogen tank T in real time. Furthermore, as necessary, the mass detector may be omitted.

The decomposition gas of the matrix resin generated inside the inner wall 11b is discharged from an exhaust port 11f that is formed in an upper portion of the inner wall 11b in the drawing, and thereafter, is introduced into the combustion chamber 12 via a pipe 11g that is installed by penetrating the outer wall 11a.

The combustion chamber 12 is an enclosed space with a periphery of the combustion chamber 12 surrounded by an outer wall 12a and an inner wall 12b. Furthermore, in the combustion chamber 12, a burner 12c is provided in a center portion of the outer wall 12a on a left side in the drawing so that the combustion gas flows to inside of the inner wall 12b. The pipe 11g penetrates the outer wall 12a, thereafter, penetrates an inside and an outside of the inner wall 12b, in the outer wall 12a, and is finally connected to an upper left portion of the inner wall 12b in the drawing. At this time, while passing through the pipe 11g inside the inner wall 12b, the decomposition gas of the matrix resin is heated by the combustion gas flowing inside the inner wall 12b, thereafter, is introduced from the upper left portion of the inner wall 12b, and contacts the combustion gas. Thereby, the decomposition gas of the matrix resin is combusted, and then is exhausted to the outside from the exhaust port 12d.

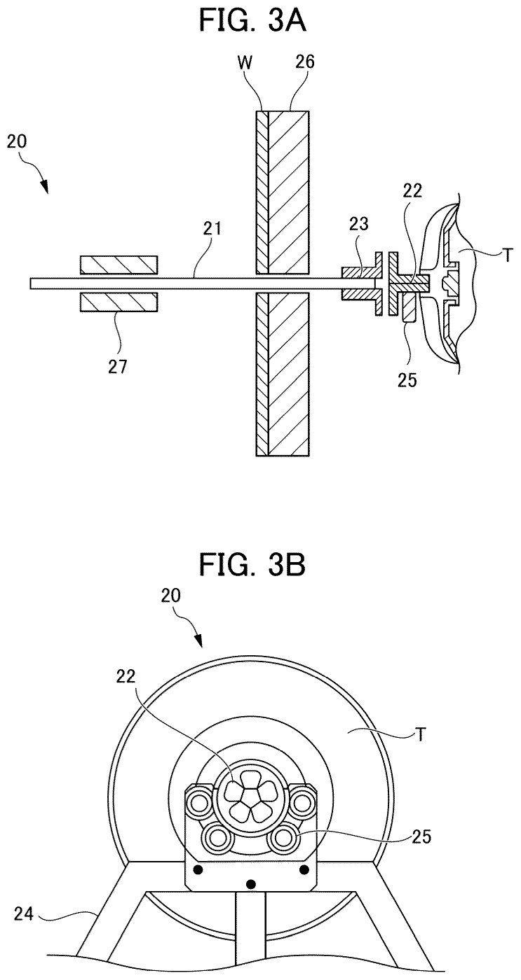

FIG. 3A and FIG. 3B each show an example of a rotator that rotates the high-pressure hydrogen tank T in the heat treatment chamber 11. Note that FIG. 3A and FIG. 3B are respectively a sectional view and a side view.

Since a rotator 20 has a rotating shaft 21 in a substantially horizontal direction penetrating the wall portion W of the heat treatment chamber 11, a temperature distribution in the carbon fiber reinforced resin layer F in the up-down direction in the drawing is made uniform.

Note that the rotating shaft 21 may be in a direction other than the substantially horizontal direction, and may be in a substantially vertical direction, for example. When the rotating shaft 21 is in the substantially vertical direction, the temperature distribution of the carbon fiber reinforced resin layer F in the heat treatment chamber 11 is made uniform to an extent corresponding to the case in which the rotating shaft 21 is in the substantially horizontal direction.

The high-pressure hydrogen tank T is connected to the rotating shaft 21 via a flange-equipped fixture 22 utilizing the shapes of the mouthpieces C1 and C2, and a rotating shaft flange 23. In this case, the flange-equipped fixture 22 and the rotating shaft flange 23 are fixed with bolts and nuts, for example. Furthermore, the high-pressure hydrogen tank T is placed on a pedestal 24, and bearings 25 are installed on the pedestal 24. Furthermore, a thermal insulator 26 is installed inside of the wall portion W of the heat-treating furnace 10. Furthermore, a motor that rotates the rotating shaft 21 is installed outside of the wall portion W of the heat-treating furnace 10, and a cooling jacket 27 is installed around the rotating shaft 21.

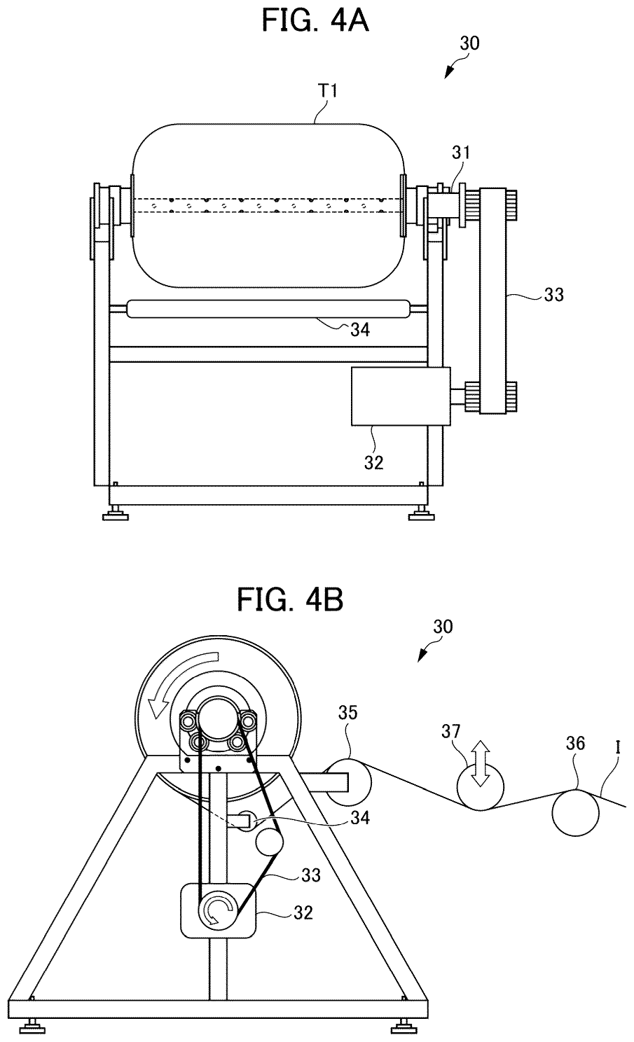

FIG. 4A and FIG. 4B each show an example of an unwinder that is used in an unwinding process. Note that FIG. 4A and FIG. 4B are respectively a sectional view and a side view.

An unwinder 30 has a rotating jig 31 that rotatably supports a high-pressure hydrogen tank T1 in which a part of the matrix resin is decomposed, and a motor 32 that rotates the high-pressure hydrogen tank T1. Rotational power of the motor 32 is transmitted to the rotating jig 31 via a belt 33. As a result, the intermediate carbon fiber bundle I is unwound via rollers 34, 35, and 36. In this case, the roller 34 is disposed so that the intermediate carbon fiber bundle I is unwound to outside from a tangent line in a position where the intermediate carbon fiber bundle I is unwound in the high-pressure hydrogen tank T1. Furthermore, the rollers 34, 35, and 36 have long shafts to correspond to unwinding of the intermediate carbon fiber bundle I in the lengthwise direction of the high-pressure hydrogen tank T1. Furthermore, in order to absorb a difference in an unwinding amount per one rotation by hoop winding and helical winding of the intermediate carbon fiber bundle I, a dancer roller 37 that controls unwinding tension is installed.

Note that instead of the roller 34, a blade may be installed.

A heating temperature in the second heating process is preferably equal to or higher than the heating temperature in the first heating process. This makes it easier to decompose the decomposition residue of the matrix resin adhering to the intermediate carbon fiber bundle I. On the other hand, the heating temperature in the second heating process is preferably equal to or lower than the thermal decomposition start temperature of the carbon fiber. Thereby, deterioration of the carbon fibers is suppressed.

Note that after the sizing process for sizing the regenerated carbon fiber bundle R is carried out, the regenerated carbon fiber bundle R that is sized may be wound.

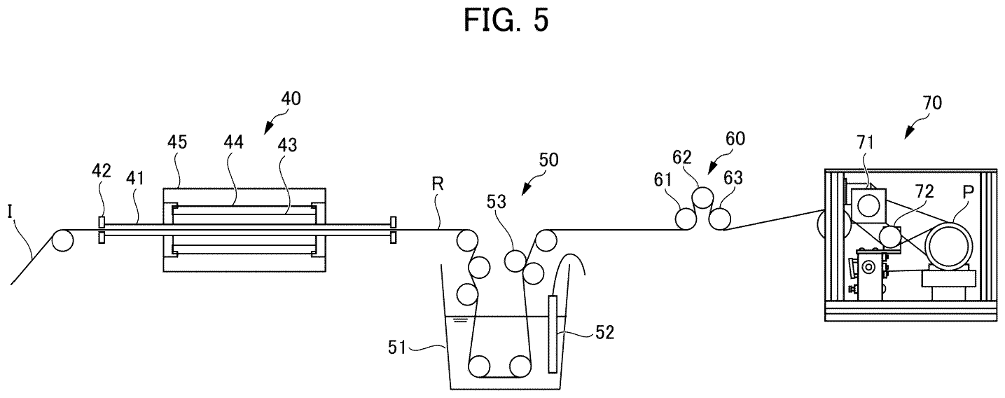

FIG. 5 shows examples of a second heater, a sizing unit, and a winder that are used in the second heating process, the sizing process, and the winding process.

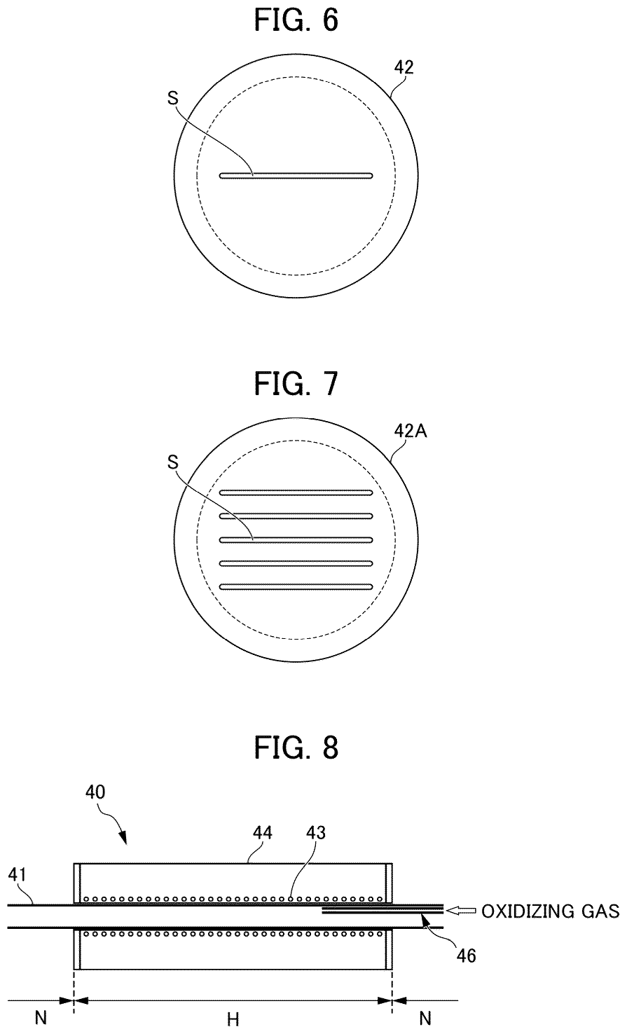

In the tube furnace 40 as the second heater, a thermally insulated lid 42 (see FIG. 6) in which a slit-shaped through-hole S where the intermediate carbon fiber bundle I to which the decomposition residue of the matrix resin is adhering can pass is formed is installed at each of an inlet and an outlet, that is, both end portions of a quartz tube 41. Here, the slit-shaped through-hole S is formed in a horizontal direction. Furthermore, in the tube furnace 40, an electric wire heater 43, a thermal insulator 44, and a protection cover 45 are sequentially installed in a center portion of the quartz tube 41. Accordingly, by the electric wire heater 43, the intermediate carbon fiber bundle I is heated, the decomposition residue of the matrix resin is decomposed, and thereby the regenerated carbon fiber bundle R is obtained.

Note that when heating a plurality of intermediate carbon fiber bundles I, it is possible to use a thermally insulated lid 42A (see FIG. 7) in which a plurality of slit-shaped through-holes S are formed. Furthermore, the shape of the through-hole formed in the thermally insulated lid is not limited to the slit shape, as long as the intermediate carbon fiber bundle I can pass through the through-hole.

As shown in FIG. 8, in the tube furnace 40, a heating region H where the intermediate carbon fiber bundle I is heated, and a non-heating region N where the intermediate carbon fiber bundle I is not heated are present. That is to say, the electric wire heater 43 is wound around the quartz tube 41 composing the heating region H, and the electric wire heater 43 is not wound around the quartz tube 41 composing the non-heating region N. Here, the non-heating region N is present between an end portion on an inlet side of the quartz tube 41 and the heating region H, and between an end portion on an outlet side of the quartz tube 41 and the heating region H. Accordingly, natural convection vortex occurs due to a temperature difference between the heating region H and the non-heating region N, and as a result, atmospheric gas of the heating region H remains.

In the tube furnace 40, an introduction tube 46 that introduces oxidizing gas into the heating region H is installed. In this case, by introducing minimal oxidizing gas, carbon dioxide included in the remaining atmospheric gas in the heating region H is discharged, and thereby a composition and a temperature of the atmospheric gas in the heating region H are maintained. Furthermore, the oxidizing gas is introduced along a surface of the intermediate carbon fiber bundle I. This suppresses fluff of the regenerated carbon fiber bundle R. Furthermore, the oxidizing gas is introduced from a downstream side to an upstream side of the tube furnace 40. This makes it easy to decompose a trace amount of decomposition residue of the matrix resin adhering to the intermediate carbon fiber bundle I on the downstream side of the tube furnace 40. Furthermore, the introduction tube 46 is disposed along an upper surface of the quartz tube 41. Accordingly, the oxidizing gas introduced into the heating region H forms a turbulent flow. At this time, in order that the oxidizing gas introduced into the heating region H forms a turbulent flow, a temperature of the oxidizing gas may be kept at a room temperature, or the oxidizing gas may be introduced intermittently.

Although the oxidizing gas is not particularly limited, as long as the gas promotes oxidization of the decomposition residue of the matrix resin adhering to the intermediate carbon fiber bundle I, oxygen is cited, for example.

Note that the heating region H may be divided into a plurality of regions. Furthermore, the introduction tube 46 does not have to be disposed along the upper surface of the quartz tube 41.

A sizing unit 50 causes the regenerated carbon fiber bundle R to pass through a sizing liquid 51. At this time, a heater 52 heats the sizing liquid 51. Furthermore, a roller 53 prevents excessive application of the sizing liquid 51 to the regenerated carbon fiber bundle R.

Note that as necessary, a drying furnace may be installed to dry the regenerated carbon fiber bundle R.

A feeding mechanism 60 has feeder rollers 61, 62, and 63, and uses friction between the feeder rollers 61, 62 and 63 and the regenerated carbon fiber bundle R to control a linear speed of the regenerated carbon fiber bundle R to a linear speed that facilitates process management.

A winder 70 includes a winding motor 71 for winding the regenerated carbon fiber bundle R on a paper core P, and a slide roller 72 for traverse winding of the regenerated carbon fiber bundle R. In this case, by controlling torque of the winding motor 71, winding tension of the regenerated carbon fiber bundle R is controlled.

Although the embodiment of the present invention is described above, the present invention is not limited to the above-described embodiment, and the above-described embodiment may be appropriately changed within the scope of the gist of the present invention. For example, as the structures other than the high-pressure hydrogen tank, propeller shafts, safety blocks, low-friction rolls, rotor parts of spindle shaft motors and the like may be used.

### EXPLANATION OF REFERENCE NUMERALS

40 tube furnace
42, 42A thermally insulated lid
43 electric wire heater
46 introduction tube
C1, C2 mouthpiece
F carbon fiber reinforced resin layer
H heating region
I intermediate carbon fiber bundle
L liner
N non-heating region
R regenerated carbon fiber bundle
S slit-shaped through-hole
T, T1 high-pressure hydrogen tank

What is claimed is:

1. A method for regenerating a carbon fiber bundle from a structure having a hollow substrate, and a carbon fiber reinforced resin layer including a carbon fiber bundle that is wound around the hollow substrate, and a matrix resin, the method comprising:
a first heating process of heating the structure to decompose a part of the matrix resin;
an unwinding process of unwinding an intermediate carbon fiber bundle to which decomposition residue of the matrix resin is adhering from the carbon fiber reinforced resin layer in which a part of the matrix resin is decomposed;
a second heating process of heating the unwound intermediate carbon fiber bundle to decompose the decomposition residue of the matrix resin by using a tube furnace, and thereby obtaining a regenerated carbon fiber bundle; and
a winding process of winding the regenerated carbon fiber bundle, wherein
the tube furnace has a heater that heats the intermediate carbon fiber bundle, and a lid that is installed at each of an inlet and an outlet, and has at least one through-hole through which the intermediate carbon fiber bundle can pass through formed in the lid.

2. The method for regenerating a carbon fiber bundle according to claim 1, wherein,
in the tube furnace, a heating region where the intermediate carbon fiber bundle is heated, and a non-heating region where the intermediate carbon fiber bundles is not heated are present, and
the non-heating region is present between the heating region and the inlet and/or between the heating region and the outlet.

3. The method for regenerating a carbon fiber bundle according to claim 2, wherein the tube furnace further has an introduction tube that introduces oxidizing gas into the heating region.

4. The method for regenerating a carbon fiber bundle according to claim 3, wherein the oxidizing gas is introduced along a surface of the intermediate carbon fiber bundle.

5. The method for regenerating a carbon fiber bundle according to claim 3, wherein the oxidizing gas is introduced from a downstream side to an upstream side of the tube furnace.

6. The method for regenerating a carbon fiber bundle according to claim 3, wherein the introduction tube is disposed so that the oxidizing gas that is introduced into the heating region forms a turbulent flow.

7. The method for regenerating a carbon fiber bundle according to claim 1, wherein the at least one through-hole is slit-shaped, and is formed in a horizontal direction.

8. The method for regenerating a carbon fiber bundle according to claim 1, wherein in the lid, a plurality of the through-holes are formed.

9. An apparatus that regenerates a carbon fiber bundle from a structure having a hollow substrate, and a carbon fiber reinforced resin layer including a carbon fiber bundle that is wound around the hollow substrate, and a matrix resin, the apparatus comprising:
a first heater that heats the structure to decompose a part of the matrix resin;
an unwinder that unwinds an intermediate carbon fiber bundle to which decomposition residue of the matrix resin is adhering from the carbon fiber reinforced resin layer in which a part of the matrix resin is decomposed;
a second heater that heats the unwound intermediate carbon fiber bundle to decompose the decomposition residue of the matrix resin, and thereby obtains a regenerated carbon fiber bundle; and
a winder that winds the regenerated carbon fiber bundle, wherein
the second heater is a tube furnace having a heater that heats the intermediate carbon fiber bundle, and a lid that is installed at each of an inlet and an outlet, and has a through-hole through which the intermediate carbon fiber bundle can pass through formed in the lid.
